(19) United States
(12) Patent Application Publication
(10) Pub. No.: US 2008/0129684 A1
(43) Pub. Date: Jun. 5, 2008

(54) Display system having viewer distraction disable and method

(76) Inventors: Jay J. Adams, Noblesville, IN (US); Craig A. Tieman, Westfield, IN (US)

Correspondence Address: DELPHI TECHNOLOGIES, INC., M/C 480-410-202, PO BOX 5052, TROY, MI, 48007, US

(21) Appl. No.: 11/606,740

(22) Filed: Nov. 30, 2006

(51) Int. Cl. G09G 5/00; G09G 3/20

(52) U.S. Cl. 345/156; 345/55

(57) ABSTRACT

A display system and a method of controlling a multiple-view display in a vehicle are provided. The display system includes a display for generating a first image that is viewable within a driver viewing window and a passenger image that is viewable within a passenger viewing window. The display system also includes sensors for sensing location of a driver of the vehicle. The display system further includes a controller for controlling the first and second images shown on the display. The controller disables the presentation of at least some image content in the passenger viewing window when the driver is determined to be attempting to view the passenger image.

### TECHNICAL FIELD

The present invention generally relates to electronic display systems and, more particularly, relates to controlling a viewing window of the video display to minimize distraction to an unintended viewer.

### BACKGROUND OF THE INVENTION

Automotive vehicles are frequency equipped with various electronic entertainment and information systems and mobile multimedia devices, generally referred to herein as infotainment systems. Infotainment systems generally include automotive personal computing devices installed in vehicles to allow personal computing, web browsing, accessing e-mail, and other Internet access. Additionally, infotainment systems include navigation systems, DVDs, televisions and video game systems. These and other infotainment systems typically include a human machine interface (HMI) for enabling the user to interface with the system. The HMI typically includes a display for viewing messages, navigational maps, video images and other information. The HMI also includes input controls for allowing manipulation by a user to input commands to the infotainment system.

Recently, dual-view displays have been developed and proposed for use on vehicles to allow two different image contents to be displayed on the same physical display. The two different display images are typically viewable from either the left side in the left or driver viewing window or the right side in the right or passenger viewing window. The dual-view display for use in an infotainment system in a vehicle allows the driver of the vehicle to view limited image contact when the vehicle is moving, such as navigational and other driver relevant content, while allowing a non-driving passenger to view different display images, such as movies, games, Internet output and other image content. Thus, the driver of the vehicle may not be distracted by image content that is not relevant to driving, while at the same time allowing the passenger to view other image content.

With the current proposed dual-view displays, there is nothing to prevent the driver of the vehicle from leaning over to the center of the vehicle and viewing the display from an angle more in-line with the passenger, particularly in the passenger viewing window. If the driver of the vehicle leans over and into the passenger viewing window, the driver may be able to view display image content, such as video, presented to the passenger. The driver viewing the passenger display content can be considered a distraction to the driver. As a result of this distraction concern, vehicle manufacturers are less likely to offer dual-view displays in vehicles. Additionally, laws and regulations may prohibit the use of such displays based on such uncontrolled driver activity.

Accordingly, it is therefore desirable to provide for a display system that allows for the viewing of image content by an intended viewer, such as a passenger of a vehicle, while prohibiting the viewing of such display image content by an unintended viewer, such as a driver of the vehicle. It is further desirable to provide for a dual-view display that may be useful in a vehicle to allow occupants in the vehicle to view video image content and to prohibit the viewing of such content by the driver of the vehicle.

### SUMMARY OF THE INVENTION

In accordance with the teachings of the present invention, a display system and method are provided for controlling the presentation of display image content to one or more viewers. According to one aspect of the present invention, a display system is provided having a display for presenting an image that is viewable within a viewing window. The display system also has a sensor arrangement for sensing when a potential unintended viewer is attempting to view the image in the viewing window. The display system further includes a controller for controlling image presented on the display based on the sensed location of the potential unintended viewer attempting to view the image. The controller disables the presentation of at least some image content when the potential unintended viewer is attempting to view the image in the viewing window.

According to another aspect of the present invention, a display system having a dual-view display is provided. The display system includes a display for presenting a first image that is viewable within a first viewing window by a first viewer and a second image that is viewable within a second viewing window by a second viewer. The display system also includes a sensor arrangement for sensing when a first viewer is attempting to view the image in the second viewing window. The display system further includes a controller for controlling the first and second images presented on the display and for disabling the presentation of at least some image content in the second viewing window when the sensor arrangement detects that the first viewer is attempting to view the image in the second viewing window.

According to a further aspect of the present invention, a method of controlling image content viewable in a display is provided. The method includes the steps of generating an image on a display that is viewable within a viewing window, sensing location of a potential unintended viewer relative to the viewing window, and determining whether the potential unintended viewer is expected to be viewing the image from within the viewing window. The method also includes the step of controlling image content shown on the display in the viewing window to prohibit viewing of at least some image content when the potential unintended viewer is determined to be located within the viewing window. According to yet a further aspect of the present invention, the method generates first and second images in first and second viewing windows for viewing by first and second viewers, and controls the images so as to disable the presentation of at least some of the image content in the second viewing window when sensing the first viewer is attempting to view the image in the second viewing window.

The display system and method of the present invention advantageously allow for controlled presentation of display image content made available to a viewer, such that at least some image content may be disabled for viewing by an unintended viewer. The system and method are particularly well-suited for use in a vehicle to allow viewing by passenger occupant within the vehicle, while prohibiting distractive viewing of image by the driver of the vehicle.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a forward view of a vehicle passenger compartment having an infotainment system equipped with a display system according to one embodiment of the present invention;

FIG. 2 is a left side front view of the infotainment system displaying image content seen by the driver of the vehicle;

FIG. 3 is a right side front view of the infotainment system displaying image content seen by a passenger in the vehicle;

FIG. 4 is a block diagram illustrating the display system with controls for controlling the image content according to one embodiment of the present invention;

FIG. 5 is an exploded view of the dual-view display and touch sensitive screen;

FIG. 6 is a flow diagram illustrating a method of controlling the display system to control image content provided in the first and second viewing windows based on user input, according to one embodiment;

FIG. 7 is a plan view of the vehicle passenger compartment illustrating sensors for sensing location of a driver shown normally seated relative to the display viewing windows, according to one embodiment;

FIG. 8 is a plan view of the vehicle passenger compartment further illustrating one example of the driver leaning over towards a passenger viewing window; and

FIG. 9 is a flow diagram illustrating a method of controlling the display to prohibit driver viewing of image content during a potentially distractive situation.

### DESCRIPTION OF THE PREFERRED EMBODIMENTS

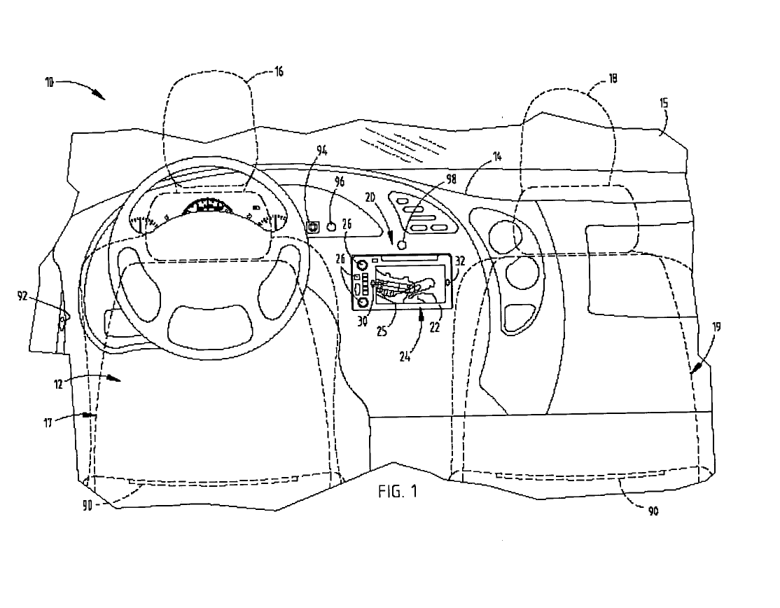

Referring to FIG. 1, the front passenger compartment 12 of a vehicle 10 is generally illustrated showing a driver 16 seated in a driver seat 17 and a front passenger 18 seated in a passenger seat 19 in the vehicle 10. The passenger compartment 12 generally includes a dash 14 with various conventional devices, such as an instrument cluster located at the front of the passenger compartment, forward of the steering wheel and steering column. The dash 14 extends in front of both the driver 16 and front passenger 18 and is located below the front windshield 15.

Centrally mounted within the dash 14 in the front side of the passenger compartment is an electronic infotainment system 20 which is readily accessible to both a first user shown as the driver 16 of the vehicle 10 on the left side and a second user shown as the front passenger 18 on the right side. The infotainment system 20 is an electronic system which generally includes any of a variety of information, entertainment and multimedia systems commonly known in the art. For example, the infotainment system 20 may include any one or a combination of the following systems: an automotive personal computing device, a web browser, an Internet access device, a satellite communication system, a mobile multimedia system, a radio, a television, a DVD player, a video game player, a navigation system, and a phone/address book lookup system, a rear or side obstruction system, a vehicle information and control system, and other types of electronic devices and systems.

The infotainment system 20 includes a human machine interface (HMI) for allowing occupants, including the driver 16 and front passenger 18 to interface with the infotainment system 20. The HMI includes a display system 24 for displaying images, including video images, maps, menus, text messages, and other content viewable within first and second viewing windows, according to one embodiment of the present invention. The display system 24 is mounted to a housing 22. The display system 24 has a dual-image display 25 that generates a first image readily viewable by the driver 16 on the left side in a first viewing window, and simultaneously generates a second image readily viewable by a front passenger 18 on the right side in a second different viewing window. However, the display system 24 may include a display 25 providing any of a number of a plurality of viewing windows for generating image content that is viewable within the viewing windows and may vary from the image content of other viewing windows.

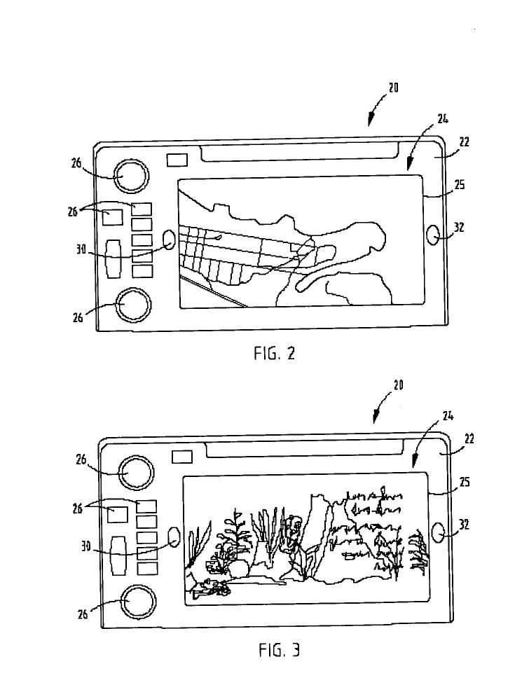

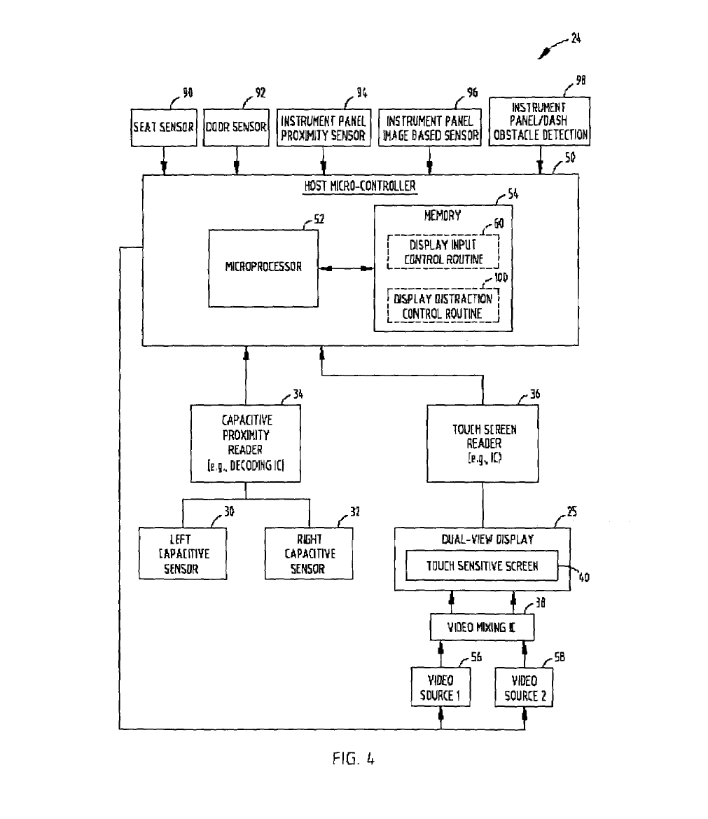

Referring to FIGS. 2 and 3, the infotainment system 20 is further illustrated as seen from the two different viewing windows. In FIG. 2, the display system 24 presents a first image in a first viewing window, such as a navigation map in the first viewing window, for viewing from the left or driver side of the vehicle. In FIG. 3, the display system 24 presents a second image, such as movie video, in the second viewing window for viewing from the right or passenger side of the vehicle. It should be appreciated that the first and second viewing windows presented in FIGS. 2 and 3 may be simultaneously displayed on the display system 24 to provide different image content to the separate viewing windows.

The HMI of the infotainment system 20 is shown in FIGS. 1-3 including various user manipulatable input controls 26 that may include pushbutton, rotary dial and other user actuated input controls. Additionally, the display system 24 includes touch screen user inputs on a touch sensitive display screen. The touch screen user inputs are user manipulatable such that a user may touch the touch sensitive screen to input commands to the display system 24.

Referring to FIG. 4, the display system 24 according to one embodiment is generally illustrated having a dual-view display 25 with touch sensitive screen 40, a left capacitive sensor 30, a right capacitive sensor 32 and a host microcontroller 50. The host microcontroller 50 includes a microprocessor 52 and memory 54. Memory 54 contains routines including a display input control routine 60 and a display distraction control routine 100 for processing sensed data and generating control signals to control any of a number of functions related to the display system 24. It should be appreciated that the host microcontroller 50 may include a dedicated controller or may be a shared controller performing any of a number of other functions.

The display system 24 also includes video mixing integrated circuitry (IC) 38 and first and second video sources 56 and 58. The first video source 56 generates signals for a first video image containing the first image content. The second video source 58 generates signals for a second video image containing the second image content. The video mixing integrated circuitry 38 receives the signals with the first and second image contents and provides the first and second image contents to the dual-view display 25 to be displayed in the first and second viewing windows, respectively.

The display system 24 further includes a touch screen reader 36 for detecting user manipulation of the touch sensitive screen 40. The touch screen reader 36 may be implemented as integrated circuitry (IC) or other known user input sensing device. The touch sensitive screen 40 allows the user to manipulate “soft” buttons that are displayed on the display screen. Examples of “soft” buttons may include navigation map centering functions, AM/FM radio functions/presets and other feature menu items.

The touch sensitive screen 40 may include a resistive panel according to one embodiment, wherein the touch screen reader 36 determines the location where the user finger is pressing against the screen. The touch screen reader 36 may include an integrated circuit configured to read the X and Y coordinates of the sensed pressure point on the screen and forward the X and Y coordinate information to the host microcontroller 50 for processing therein. Alternately, the touch screen reader 36 may be implemented in software or otherwise configured to sense “soft” buttons on the touch sensitive screen. According to other embodiments, the touch screen reader 36 may include an array of infrared transmitters and receivers that, once the screen 40 is touched or close to being touched, the infrared beam is broken in an X and Y direction and relayed back to the host microcontroller 50.

The display system 24 further includes a capacitive proximity reader 34 coupled to the left capacitive sensor 30 and the right capacitive sensor 32. The capacitor proximity reader 34 may be implemented as a decoding integrated circuit, or otherwise configured to sense signal outputs from the left and right capacitive sensors 30 and 32 to establish the proximity of a user relative thereto. In one embodiment, the left and right capacitive sensors 30 and 32 include capacitive proximity circuits that measure a capacitive value from copper pads on a circuit board. The capacitive value has a magnitude that may vary based on proximity to a user. One example of an IC capacitive sensor is Model No. QT220, commercially available from Quantum Research Group.

The capacitive proximity reader 34 reads the capacitive value from each of the left and right capacitive sensors 30 and 32. The capacitor proximity reader 34 may also determine if the capacitive value of the left capacitive sensor is greater than the capacitor value of the right capacitive sensor 32, indicative that a left-side user event has occurred and provides an output signal to the microcontroller 50. If the capacitive value of the right capacitive sensor 32 is greater than the left capacitive sensor value, the capacitor proximity reader 34 sends an output signal to the host microcontroller 50 indicating that a right side user event occurred. According to other embodiments, the comparison of the capacitor values of the left and right capacitive sensors 30 and 32 and the determination as to which side a user manipulation has occurred may be determined elsewhere, such as in the host microcontroller 50.

In the embodiment shown, the proximity sensors employ capacitive sensors 30 and 32, located on opposite sides of the display 25 for sensing the user, such as the hand of the user, in close proximity thereto to determine if the user is expected to be in the first or the second viewing windows. According to other embodiments, the presence of a user manipulating the input to the display system 24 may be detected using other in various configurations. For example, the left and right sensors may include optical sensors, light sensors, infrared sensors, or other sensing devices. While the sensors 30 and 32 are shown placed on the left and right sides of the display 25, the sensors 30 and 32 could be placed closer together or located at various locations on or off the infotainment system 20.

The display system 24 is shown in FIG. 4 having a display distraction routine 100 according to one embodiment of the present invention. The display distraction routine 100 monitors the location of the driver of the vehicle and determines if the driver is leaning sufficiently towards the passenger viewing area, such that the driver may be attempting to view the passenger display content viewable in the passenger viewing window. The display distraction control routine 100 essentially monitors the position of the driver with a sensor arrangement of one or more sensors and, if the driver is determined to be located in a potentially distractive position, the control routine 100 disables the display of at least some of the passenger side image content such that the driver is less likely to be distracted.

The display system 24 is shown in FIGS. 1, 4, 7 and 8 including several sensors arranged for sensing the location of the driver 16. The sensors include a seat mounted pressure/weight-based sensor 90 located in the driver's seat 17. The sensor 90 may include a fluid-filled bladder with a pressure sensor, such as the type employed for passive occupant detection systems, or other such known sensors. The pressure weight-based sensor 90 in driver's seat 17 may indicate the presence of a driver 16 and the driver's weight distribution, such as whether the driver 16 is distributing a substantial portion of weight towards the passenger side or center of the vehicle, indicative of the driver 16 leaning over to attempt to view the passenger displayed image content.

The passenger seat 19 may also be equipped with pressure/weight-based sensor 90 for sensing the presence of a passenger in the passenger seat 19. By knowing whether or not a passenger is present, the display system 24 can further control the image content displayed in the passenger viewing window. If a passenger is not present, the image content displayed in the passenger viewing window may be limited to only the available driver's image content or the passenger display may be turned off.

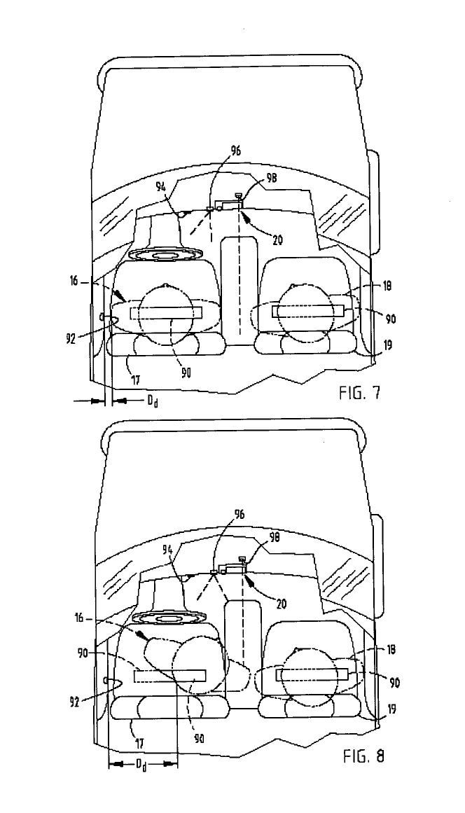

The display system 24 may also include a door mounted proximity-based sensor 92 that detects the lateral distance of the driver from the driver side door. Sensor 92 may include an electrostatic field sensor, according to one example. As seen in FIG. 7, the door mounted proximity-based sensor 92 detects a distance D_{d} between the door sensor 92 and the driver 16 that is sufficiently small when the driver is in the normally seated position. As seen in FIG. 8, when the driver 16 is leaning towards the passenger side of the vehicle, the proximity-based sensor 92 detects an increased distance D_{d} indicative of the driver 16 of the vehicle 10 is leaning towards the center or the passenger side of the vehicle and may be attempting to view the passenger side display content in the passenger viewing window.

Also included in the display system 24 is an instrument panel mounted proximity-based sensor 94 that detects distance from instrument panel to the driver 16 and whether the driver 16 is leaning towards the passenger side. Examples of sensor 94 may include an electrostatic field sensor, an ultrasonic sensor, a radar sensor, an active infrared sensor, or other known proximity sensor.

An instrument panel mounted image-based sensor 96 is also shown that detects driver position relative to the sensor 96. The image-based sensor 96 may include a camera or other known image acquisition device. The images acquired by sensor 96 can be processed to recognize the driver 16 and the driver's location using known image recognition and processing routines.

An instrument panel mounted obstacle detection sensor 98 is shown mounted centrally in the instrument panel or dash 14 and detects driver entry into a zone-of-coverage, such as a zone between a normally seated driver and a passenger. Examples of sensor 98 may include an active infrared sensor, a radar sensor, an ultrasonic sensor, a camera or other known sensor.

The various sensors 90-98 could be mounted in various other locations within the passenger compartment of the vehicle to detect the position of the driver 16. For example, sensors 90-98 could be located in the head unit, in the vehicle seat, in the headliner, in the mirror, in the instrument panel, in the A-pillar, or various other locations on board the vehicle.

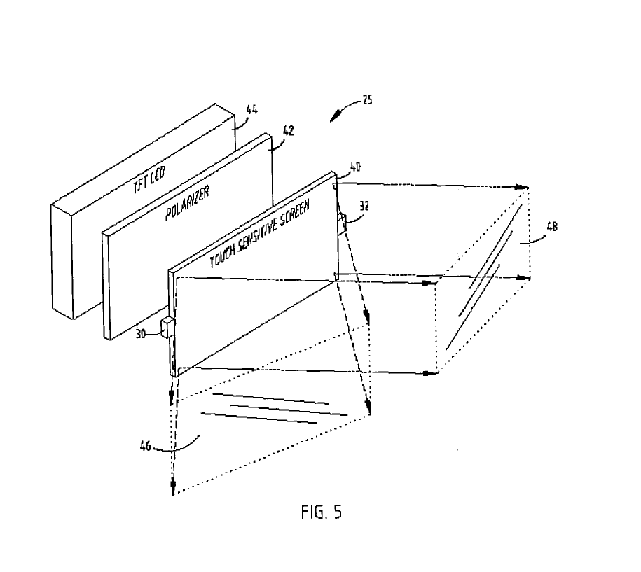

Referring to FIG. 5, one example of a dual-view display 24 is illustrated having an overlaying touch sensitive screen 40. The proximity sensors 30 and 32 are shown mounted on the left and right sides of the touch sensitive screen 40. The dual-view display 25 has a thin film transistor (TFT) liquid crystal display (LCD) 44, according to one embodiment. The LCD 44 generally includes a backlight and transistors configured to control the video pixels. Additionally, the dual-view display 25 includes a polarizer 42 disposed in front of the LCD 44 to cause the light from the backlight of the LCD 44 to separate into right and left directions within the first and second viewing windows. According to one example, the polarizer 42 may include a parallax barrier superimposed on the LCD 44. The resulting dual-view display 25 allows the first and second video images provided by video sources 56 and 58 to be presented on the LCD 44, and directed via polarizer 42 into first and second viewing windows shown by arrows 46 and 48.

One example of a dual-view display 25 is disclosed in U.S. application Ser. No. 11/434,546, filed on May 15, 2006, which is hereby incorporated herein by reference. The dual-view display 25 may include a seven inch (7″) dual view display produced by Sharp Corporation. The use of a dual-view display in a vehicle is known in the art. It should be appreciated that other types of displays may be employed to provide the dual-view image content. It should further be appreciated that other types of displays that include single or more than two image view windows may be employed. For example, the display disclosed in U.S. Patent Application Publication No. 2005/0179827, filed on Feb. 17, 2004, which discloses a display system having electronically controlled viewing window that may change the size of the window from passenger viewing only to both passenger and driver viewing. The aforementioned published patent application is hereby incorporated herein by reference.

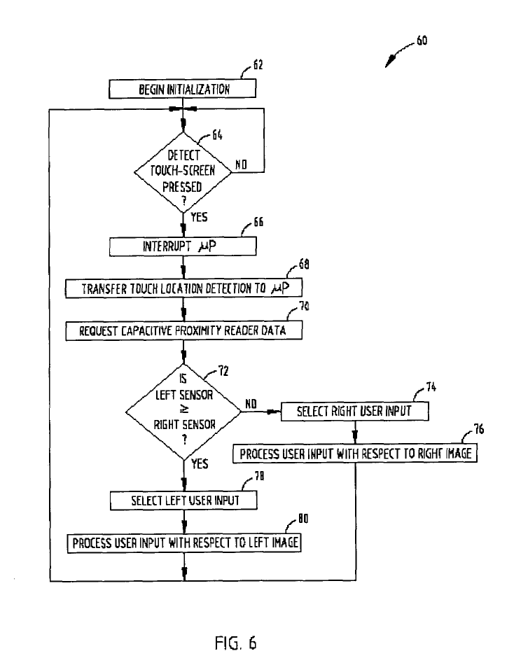

The display input control routine 60 is illustrated in FIG. 6 according to one embodiment. The routine 60 begins with an initialization step 62. The initialization step 62 may include software calibrations that could happen at power-up or at specific time-sampled intervals. For example, if other objects are expected to be placed in close proximity to the display system, that could potentially interfere with the sensors, the microcontroller 50 could perform periodic calculations, such as every ten seconds, in order to be able to make an accurate determination of left or right side user detection by the left and right side sensors, respectively.

Following initialization, the routine 60 proceeds to step 64 to detect if the touch sensitive screen has been depressed. If the touch sensitive screen has been pressed, routine 60 proceeds to interrupt the microprocessor in step 66 and then transfers the touch location detection, such as the X and Y coordinates of the location of the touch on the screen, to the host microprocessor in step 68. Next, routine 60 requests the capacitive proximity reader data in step 70. The reader data is then compared to see if the left sensor data is greater than the right sensor data in decision step 72. If the left sensor data is determined to be greater than the right sensor data, routine 60 selects the left user input in step 78 and proceeds to process the user input with respect to the left image in step 80. If the left sensor is not determined to be greater than the right sensor data, routine 60 selects the right user input in step 74 and then proceeds to process the user input with respect to the right image in step 76.

Accordingly, the display input control routine 60 detects which viewing window the user manipulating the touch sensitive screen is expected to be located within, based on the sensed proximity to the left and right detection sensors. It should be appreciated that other user inputs may be employed in addition to or in place of the touch sensitive screen. The sensed proximity data may then be used to control the image content provided in the first and second images to the respective first and second viewing windows. For example, the image content for a navigation system displayed to the driver of the vehicle may be modified such as to recenter the navigation map when the display system 20 detects a user is manipulating the touch sensitive screen to enter such a command. If a passenger is determined to be manipulating the touch sensitive screen, the second image content provided to the right side viewing window is controlled based on the user manipulated input command.

The display system 24 is configured to detect when the driver 16 of the vehicle 10 is in an improper position leaning towards the center, or more specifically towards the passenger side of the vehicle such that the driver 16 of the vehicle 10 may be attempting to view the passenger side display image content. One example of a driving scenario when the driver 16 is leaning towards the passenger side is illustrated in FIG. 8. As the driver leans towards the passenger viewing area, one or more of sensors 90-98 detects the location of the driver 16 and provides the detected signal information to the controller 50. The controller 50, specifically the microprocessor 52, executes the display distraction control routine 100 and controls at least some of the passenger view image content such that the driver of the vehicle, as an unintended viewer of that content, is unable to view the passenger image content. Upon detecting such a situation, the passenger display may be switched to display driver display content, the passenger viewable display may be turned off, or the driver and passenger display may be turned off. Accordingly, the driver 16 of the vehicle 10 is less likely to lean over and attempt to view the passenger image content and, hence, should not be distracted by the passenger viewable image content.

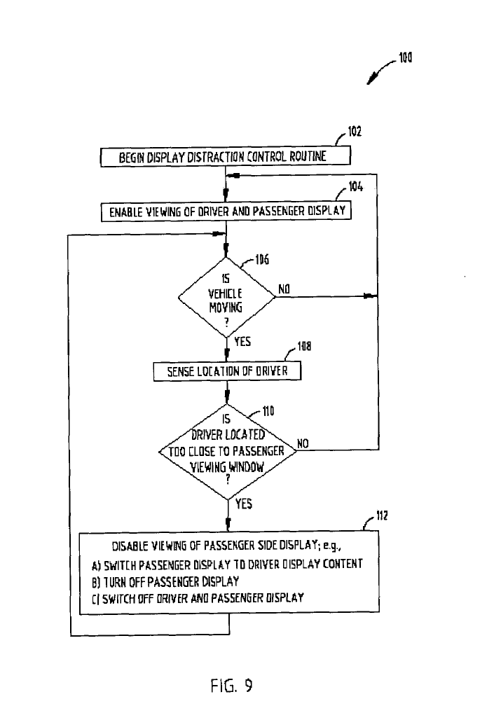

Referring to FIG. 9, the display distraction control routine 100 is illustrated according to one embodiment of the present invention. The control routine 100 begins at step 102 and proceeds to step 104 to enable viewing of the driver and passenger display images. Next, in decision step 106, the routine 100 determines whether the vehicle is moving and, if the vehicle is not moving, returns to step 104. The vehicle may be determined to not be moving if the vehicle is in a park mode or vehicle speed is near zero. It should be appreciated that enhanced or full display content may be made available for viewing in the driver's viewing window when the vehicle is not moving.

If the vehicle is determined to be moving, the control routine 100 proceeds to sense the location of the driver of the vehicle in step 108. In decision step 110, if the driver is determined to be located too close to the passenger viewing window, control routine 100 proceeds to step 112 to disable viewing of the passenger side display image content. Disabling the passenger side display image content may include: (a) switching the passenger display content to driver display content; (b) turning off the passenger display; or (c) switching off both the driver and passenger display. Following step 112, control routine 100 returns to step 106. Accordingly, if the vehicle is not moving, or if the driver is not located too close to the passenger viewing window, control routine 100 continues to display passenger image content, so long as the driver does not lean over towards the passenger viewing window.

The display system 24 and display distraction control routine 100 advantageously allow for the controlled presentation of display image content to an intended viewer, in a manner that does not distract an unintended viewer. The display system 24 and method 100 are particularly well-suited for use in a vehicle 10 to allow viewing my multiple occupants within the vehicle 10, such as a driver 16 and a passenger 18 of the vehicle 10. It should be appreciated that the display system 24 and method 100 may also be used to display image content to other passengers in the vehicle, such as passengers located in the rear seating area of a vehicle, commonly referred to as a rear seat entertainment system. For example, the display system 24 and method 100 may detect the driver attempting to lean towards the rear seating area of the vehicle passenger compartment to view the rear seat display, and may disable the presentation of rear seat entertainment image content when the driver is attempting to view such image content.

It should further be appreciated that the display system 24 and method 100 may be employed in a video display that has one or more viewing windows. For example, in a display that has a viewing window directed to the passenger of the vehicle, as opposed to the driver of the vehicle, the driver may be prohibited from viewing the passenger image content when attempting to lean towards the passenger side of the vehicle. Finally, the display system 24 and method 100 of the present invention may be employed in other environments outside of a vehicle, without departing from the teachings of the present invention.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A display system having a viewing window, said display system comprising:
a display for presenting an image having image content that is viewable within a viewing window;
a sensor arrangement for sensing when a potential unintended viewer is attempting to view the image in the viewing window; and
a controller for controlling the image presented on the display based on the sensed location of the potential unintended viewer attempting to view the image, wherein the controller disables the presentation of at least some image content when the potential unintended viewer is attempting to view the image in the viewing window.

2. The display system as defined in claim 1, wherein the display system is located in a vehicle.

3. The display system as defined in claim 2, wherein the sensor arrangement comprises a weight-based sensor located in the seat of the vehicle for detecting location of a driver of the vehicle.

4. The display system as defined in claim 2, wherein the sensor comprises a proximity sensor located in the vehicle.

5. The display system as defined in claim 4, wherein the proximity sensor is mounted in a door of the vehicle.

6. The display system as defined in claim 2, wherein the sensor arrangement comprises an image acquisition device located within the passenger compartment of the vehicle for detecting location of a driver of the vehicle.

7. The display system as defined in claim 2, wherein the potential viewer comprises a driver of the vehicle attempting to view the image content made available to a passenger of the vehicle.

8. The display system as defined in claim 1, wherein the display comprises a multiple-view display for generating a first image viewable within a first viewing window and a second image viewable within a second viewing window, wherein the potential viewer is allowed to view image content in the first viewing window and is prohibited from viewing at least some image content in the second viewing window.

9. The display system as defined in claim 8, wherein the display system is located in a vehicle such that the first image in the first viewing window is viewable by a driver of the vehicle and the second image in the second viewing window is viewable by a passenger in the vehicle.

10. A display system having a multiple-view display, said display system comprising:
a display for presenting a first image that is viewable within a first viewing window by a first viewer and a second image that is viewable within a second viewing window by a second viewer;
a sensor arrangement for sensing when the first viewer is attempting to view the second image in the second viewing window; and
a controller for controlling the first and second images presented on the display and for disabling the presentation of at least some image content in the second image in the second viewing window when the sensor arrangement detects that the first viewer is attempting to view the second image in the second viewing window.

11. The display system as defined in claim 10, wherein the display system is located in a vehicle.

12. The display system as defined in claim 11, wherein the display system is arranged in the vehicle such that the first image in the first viewing window is viewable by a driver of the vehicle and a second image in the second viewing window is viewable by a passenger in the vehicle.

13. The display system as defined in claim 11, wherein the sensor arrangement comprises a weight-based sensor located in the seat of the vehicle for detecting location of a driver of the vehicle.

14. The display system as defined in claim 11, wherein the sensor comprises a proximity sensor located in the vehicle.

15. The display system as defined in claim 14, wherein the proximity sensor mounted in a door of the vehicle.

16. The display system as defined in claim 11, wherein the sensor arrangement comprises an image acquisition device located within the passenger compartment of the vehicle for detecting location of a driver of the vehicle.

17. A method of controlling a display to prohibit viewing of image content to an unintended viewer, said method comprising the steps of:
generating an image having image content on a display that is viewable within a viewing window;
sensing location of a potential unintended viewer relative to the viewing window;
determining whether the potential unintended viewer is expected to be viewing the image in the viewing window; and
controlling the display of the image in the viewing window to prohibit viewing of at least some of the image content when the potential unintended viewer is determined to be expected to be viewing the image within the viewing window.

18. The method as defined in claim 17, wherein the method is employed on a vehicle to provide a viewing window for viewing by a passenger of the vehicle and to prohibit viewing by a driver of the vehicle.

19. The method as defined in claim 18, wherein the step of generating an image comprises generating a first image on a display that is viewable within a first viewing window and generating a second image on the display that is viewable within a second viewing window, wherein the first viewing window is made available to a viewing by the driver of the vehicle and the second viewing window is made available for viewing by the passenger in the vehicle.

20. The method as defined in claim 18, wherein the step of sensing comprises sensing weight of the driver on a seat in the vehicle.

21. The method as defined in claim 18, wherein the step of sensing comprises sensing location of the driver relative to the viewing window.

22. The method as defined in claim 18, wherein the step of sensing comprises acquiring images of the driver and processing the acquired images.

23. A method of controlling a multiple-view display to prohibit viewing of image content to an unintended viewer, said method comprising the steps of:
generating a first image that is viewable within a first viewing window by a first viewer;
generating a second image that is viewable within a second viewing window by a second viewer;
sensing location of the first viewer relative to the second viewing window;
determining whether the first viewer is expected to be viewing the image in the second viewing window; and
controlling the display of the images in the second viewing window to prohibit viewing of at least some image content in the second image when the first viewer is determined to be expected to be viewing the second viewing window.

24. The method as defined in claim 23, wherein the method is employed in a vehicle to prohibit viewing of passenger image content in the second viewing window by a driver of the vehicle.

25. The method as defined in claim 24, wherein the step of sensing comprises sensing weight of the driver on a seat in the vehicle.

26. The method as defined in claim 24, wherein the step of sensing comprises sensing location of the driver relative to the second viewing window.

27. The method as defined in claim 24, wherein the step of sensing comprises acquiring images of the driver and processing the acquired images.
